(19) United States
(12) Patent Application Publication
(10) Pub. No.: US 2001/0032164 A1
(43) Pub. Date: Oct. 18, 2001

(54) Method and apparatus for bi-directional auctioning between buyers and sellers using a computer network

(76) Inventor: Jaekil Kim, Seoul (KR)

Correspondence Address: CISLO & THOMAS, LLP, 233 WILSHIRE BLVD, SUITE 900, SANTA MONICA, CA, 90401-1211, US

(21) Appl. No.: 09/734,797

(22) Filed: Dec. 11, 2000

(30) Foreign Application Priority Data
Mar. 15, 2000 (KR) 1999-78767

(51) Int. Cl. G06F 17/60

(52) U.S. Cl. 705/37; 705/26

(57) ABSTRACT

A method and apparatus for bi-directionally auctioning using a computer network, wherein one or more purchase prices and an accumulated purchase quantity of goods at or above each purchase price are displayed in real time. A plurality of buyers participate competitively by registering a purchase price. A higher-price-accumulated purchase quantity is then determined by summing the quantity of similar goods at or above each registered purchase price. Sellers select an acceptable purchase price competitively by referring to each displayed purchase price and higher-price-accumulated purchase quantity. A transaction between a seller selecting first and all buyers who register goods at or above the selected purchase price is consummated. A similar bi-auction system for sellers making bids and a buyer purchasing a higher-price-accumulated quantity of goods is provided by implementing the present invention mutatis mutandis with sellers as buyers and vice-versa. In that case, the higher-price-accumulated amount is at or below each registered sale price.

### BACKGROUND OF THE INVENTION

1. Field of the Invention

The present invention relates generally to a method and apparatus for performing commercial transactions using a computer network, and in particular to a method and apparatus for bi-directionally auctioning using a computer network.

2. Description of the Related Art

Typical electronic commercial transaction methods may be classified as a shopping mall method, an auction method, a Dutch auction method, a brokerage method, or a synergy auction method.

Most electronic commerce transactions adopt a shopping mall method. In a shopping mall method, sellers open a virtual marketplace on the internet and display goods to sell in the opened virtual marketplace. Buyers order goods by visiting the virtual marketplace. The shopping mall method is a seller-driven method in which a buyer buys goods after seeing the price presented by a seller. Typically, a buyer buys the goods from the cheapest shopping mall after surveying prices of the same products in a plurality of different shopping malls. Thus, a buyer has the trouble and the inconvenience of remembering the cheapest shopping mall for each of the goods after surveying prices in the plurality of different shopping malls. Also, because each shopping mall has different payment method, ordering method, delivery period and delivery fare, a buyer has the further burden of evaluating all these conditions for each purchase.

In the auction method, a seller puts up goods at auction, a large number of buyers present various prices,, and a transaction is accomplished by selecting a buyer who presents the highest price for the goods. Because the auction method determines the highest price by making a plurality of buyers compete with each other, it is necessary for buyers to make an effort to acquire the auction information and to participate in the auction by finding the auction place and the auction times for related goods.

The Dutch auction method, such as that disclosed in U.S. Pat. No. 5,794,207, is an auction in which a certain price is set and gradually lowered by the auctioneer until a bid is received, the first bidder becoming the buyer. In a Dutch auction, a large number of sellers compete for one purchase condition, and it is convenient to a buyer because it is a buyer-driven transaction. However, a seller cannot expect to make a large quantity of transactions because every transaction is consummated with only one buyer.

In the brokerage method, such as that disclosed in Korean Patent application No. 1999-78767, a transaction is consummated between a buyer and a seller whereby a buyer and a seller register a purchase price and a selling price, respectively, and a broker determines the lowest desired selling price as a contract price. In the brokerage method, a buyer and a seller register at the same time. Thus, similar to the Dutch auction, a seller cannot expect a large quantity of transactions because every transaction is consummated with one buyer. Also, the participation of more sellers is limited because a seller must register to sell to consummate a transaction. Also, the brokerage method has a problem that a seller cannot plan more positive sales strategy because a broker, rather than the seller, determines the selling quantity and selling time.

A synergy auction, as can be found at the world-wide web site of www.auction.co.kr, is a kind of a cooperative purchase method wherein goods, selling quantity, purchase quantity, and present price are displayed and a fixed amount of money is discounted in response to the increase of the purchase quantity of a corresponding good. In this method, the quantity of goods is limited in advance. A buyer cannot present a purchase price, and the purchase price falls in a fixed rate. In addition, the discountable money is restricted.

The above-described electronic commerce methods cannot accomplish the transaction of aggregate sales because they are one to one or one to majority methods between a seller and one or more buyers.

### SUMMARY OF THE INVENTION

The above-described and other drawbacks are overcome by a method for bi-directionally auctioning using a computer network. The method described herein includes displaying one or more purchase prices one or more buyers are willing to pay for goods and a higher-price-accumulated purchase quantity for each purchase price. The higher-price-accumulated purchase quantity is equal to the number of goods registered at or above the corresponding purchase price. One or more buyers participate competitively for a desired (higher) purchase price by referring to each displayed purchase price and higher-price-accumulated purchase quantity. A transaction is confirmed between the seller who has goods to sell in sufficient quantity and who first selects a displayed purchase price and higher-price-accumulated purchase quantity. The seller then sells to all buyers at or above the selected purchase price.

In another embodiment, a transaction between a plurality of buyers and a plurality of sellers is characterized by the plurality of buyers inputting data into a computer, the data including: a desired goods/model description, price, quantity, and purchase contract money. The computer then shows one or more prices, a quantity for each purchase price, and a higher-price-accumulated quantity, which is obtained by summing the quantities at or above each price. One or more sellers may then competitively select an acceptable price and higher-price-accumulated quantity among the one or more prices and accumulated quantities of each goods/model shown on the computer. The computer then consummates the transaction between the seller and the buyers. The seller sells the goods to all buyers paying at or above the seller's price. The computer then confirms the transaction between the particular seller and all buyers who have bid prices at or above the selected purchase price.

In one embodiment of the above method of the present invention, buyers input data into a computer, the data including: a goods/model description, purchase price, purchase quantity, and a registration mode. Buyers also input a single purchase contract deposit amount for the plurality of goods. When a transaction is confirmed, the goods/model description, the purchase price, and the purchase quantity, input for the single accumulated purchase quantity are deleted.

A seller may supply the entire higher-price-accumulated purchase quantity. Alternatively, the seller may supply only a portion of the higher-price-accumulated purchase quantity. In the latter embodiment, the buyers associated with the prices can be determined using a ranking system.

In another embodiment, buyers can input a purchase term during which they will buy, registration information, and a total purchase amount. Purchase term information indicates the duration of the purchase offer and acts as a window during which the buyer's price is effective. Registration information indicates whether the registration is a plural or single registration. In a plural registration mode, the user can register a plurality of goods simultaneously using one purchase registration. In a single registration mode, the user can register by appointing a product to a group of similar products. The total purchase amount is obtained by multiplying a purchase price by its accompanying accumulated selling quantity.

In another embodiment, information for analyzing the fluctuation of purchase prices and accumulated selling quantities is displayed to help purchase strategies. Other analytical graphs can also be included, such as a graph depicting selling quantities and an accumulated selling quantity graph as to each selling price, a graph depicting confirmed selling price as a function of time, and a graph depicting the confirmed accumulated purchase transaction quantity as a function of time. These analytical graphs help sellers to register selling prices and help buyers determine appropriate purchase times and buying prices.

An apparatus, or system, for bi-directionally auctioning (goods, services, or otherwise) using a computer network includes storage means where a bi-directional auction program is stored, and a processor that executes the bidirectional auction program stored in the storage means. Each seller inputs a goods/model description, a purchase price, a purchase quantity, and purchase contract money data. The processor processes this data and includes as output a higher-price-accumulated purchase quantity, which is obtained by summing the purchase quantities for all goods priced at or above the corresponding purchase price. One or more sellers competitively select an acceptable purchase price and higher-price-accumulated purchase quantity from those displayed. The processor provides selling authority for the higher-price-accumulated purchase quantity for the selected purchase price to the seller who first selects the purchase price. The processor then confirms the transaction between the seller and all buyers who registered goods at and over the selected purchase price (buying price).

The storage means includes a member database, a purchase registration database, a purchase registration display database, a selling offer database, a selling decision database and a registered goods database in order to monitor and perform the buy/sell transactions.

### OBJECTS OF THE INVENTION

It is an object of the present invention to provide an auction system allowing buyers and sellers to purchase goods in quantity at competitive prices.

It is yet another object of the present invention to allow buyers to competitively bid for a seller's product.

It is yet another object of the present invention to allow sellers to competitively bid for a buyer's purchase.

It is another object of the present invention to allow a seller to sell in quantity to a number of buyers bidding for products with a sales price being the lowest price in a number of highest prices.

It is another object of the present invention to allow a buyer to buy in quantity from a number of sellers bidding for sales with a sales price being the highest price in a number of lowest prices.

These and other objects and advantages of the present invention will be apparent from a review of the following specification and accompanying drawings.

### BRIEF DESCRIPTION OF THE DRAWINGS

FIG. 1 is a drawing showing the configuration of a method for bi-directionally auctioning system of the present invention using a computer network;

FIG. 2 is a drawing showing a configuration of an apparatus for a bi-directional auction system of the present invention using a computer network;

FIG. 3 is a drawing showing a configuration of a buyer member database for use in the present invention;

FIG. 4 is a drawing showing a configuration of a seller member database for use in the present invention;

FIG. 5 is a drawing showing a configuration of a purchase registration database for use in the present invention;

FIG. 6 is a drawing showing a configuration of a purchase registration display database for use in the present invention;

FIG. 7 is a drawing showing a configuration of a selling offer database for use in the present invention;

FIG. 8 is a drawing showing a configuration of a purchase, or selling, decision database for use in the present invention;

FIG. 9 is a drawing showing a configuration of a registered goods database for use in the present invention;

FIGS. 10 through 13 are a flowchart illustrating operations of the present invention;

FIG. 14 is a flowchart illustrating operations of a terminal used in conjunction the present invention;

FIGS. 15 through 25 show screens illustrating the operation, as by a terminal, of the present invention; and

FIGS. 26 through 28 show various analytical graphs helpful in determining a purchase price of the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention provides means by which buyers and sellers can make and participate in markets for goods and services. Basic guiding principles are implemented so that sellers can seek highest prices while buyers can seek lowest prices. The laws of supply and demand prevail, but the wants of many buyers can be addressed simultaneously. Conversely, one buyer can purchase the goods of many sellers simultaneously. The seller purchases from a pool of buyers who indicate the highest prices at which the buyers will buy while, conversely, a buyer purchases from a pool of sellers indicating the lowest prices at which they will sell. The markets/auctions set forth herein are generally for specific good, services, etc. However, alternative embodiments allow for auction of similar, and not identical, items.

As set forth herein, buyers may set or indicate prices at which they are willing to buy. The embodiments set forth herein are equally applicable to sellers mutatis mutandis who set forth the prices at which they are willing to sell. Different buyers will have different prices at which they are willing to buy. A seller will then choose those buyers buying at higher prices. If a seller has or wants to sell more goods than what a single buyer wants, the seller can sell to other buyers bidding buying prices for the same goods.

If the seller is willing to sell at a price below the highest bid buying price, then the higher-bidding buyers may also benefit from the seller's sale if the seller has sufficient inventory and so desires to sell to the other buyers. Of course, the seller may want to “cherry pick” and only meet the market at the present highest price, picking off each resulting highest price, although each subsequent highest price will be less than the preceding one.

Such a seller may be in competition for the buyers' bids with other sellers and so may be made more anxious to make a deal in light of the competition. In accepting a lower selling price, a seller may benefit from the sale of a larger quantity.

As set forth herein, any item, article, good, or service, or any other thing that may be put up for auction may be made the subject of a sale via the bi-directional auctioning system of the present invention. Mention herein of a single thing subject to auction is contemplated as a shorthand indication for any and all things subject to auction. For example, if an item is indicated as being for sale or purchase through the present invention, that item may be any good, service, or other thing subject for sale at auction. The present invention is not limited to the sale of goods only, but may be used to sell, buy, or otherwise transact any good, service, or other thing susceptible to auction sale.

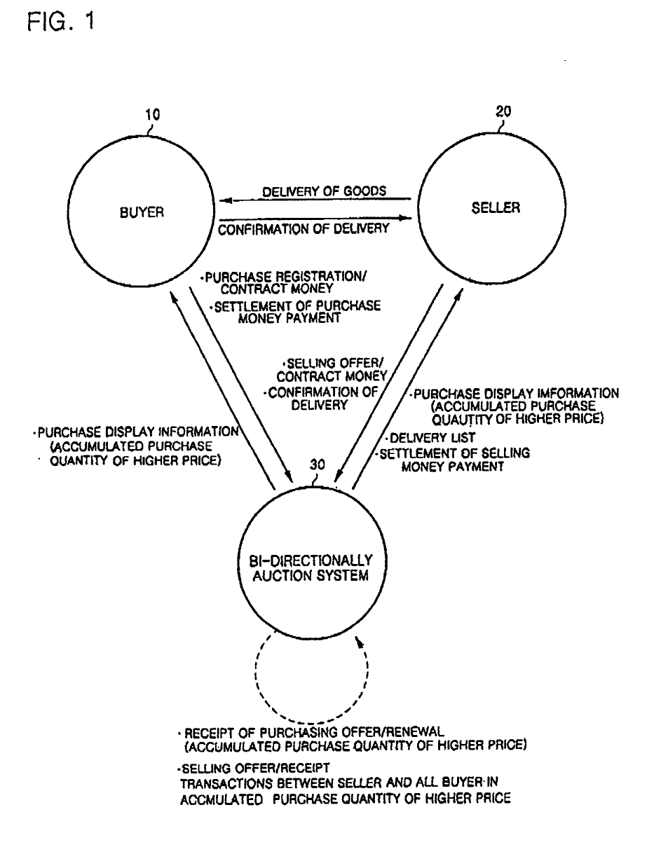

FIG. 1 shows a configuration of a method of the present invention for bi-directionally auctioning. As illustrated in FIG. 1, the bi-directional auctioning method of the present invention is accomplished by a transaction between a buyer 10 and a seller 20 that is consummated through a bi-directional auctioning system 30. Payment money is paid from the buyer 10 to the seller 20 and the seller 20 delivers the purchase product to the buyer 10.

The present invention differs from a general auction or a Dutch auction because, in the present invention, the registration of various purchase buying prices as to one product is possible and a seller can select a purchase price competitively by considering a total sum of sale money or total transaction. The total sum of sale money is determined by multiplying a higher-price-accumulated purchase quantity by the purchase-buying price. The higher-price-accumulated purchase quantity is the total number of goods at or above the seller's acceptable purchase buying price. The higher-price-accumulated purchase quantity and the total sum of sale money can be displayed for each purchase price simultaneously.

The present invention provides an expectation to buyers that they can buy a product at low price by making a large number of transactions. Also, sellers can select specific selling times in consideration of fund rotation and profit maximization.

Referring to Table 1, an example of the bilateral auction method of the present invention can be described. In Table 1, suppose that there are seven buyers, each buying a different quantity of the same type of goods at a different purchase price, each expressing a purchase buying intention on a bilateral auction site of the present invention. The goods have a production cost of 30,000 South Korean won and a general selling price (retail price) of 50,000 won. Sellers may determine a sales strategy by referring to the purchase total amount, which is obtained by multiplying the purchase price and the higher-price-accumulated purchase quantity. The higher-price-accumulated purchase quantity is the sum of the purchase-desired quantities from all goods priced at or above the purchase price. Sellers can also refer to the earnings, which are determined by subtracting the production cost of the higher-price-accumulated purchase quantity (e.g., 30,000 won times the higher-price-accumulated purchase quantity) from the purchase total amount. Said seller sells at a generally higher price and at greater convenience while all buyers buy at purchase offer purchase price or lower.

TABLE 1
Table showing principle factors for bi-directional auction for a specific good.

| | | Number | | Higher-Price- | Purchase | |
|---|---|---|---|---|---|---|
| | Purchase | of | Purchase | Accumulated | total | |
| | price | Buyers | quantity | quantity | amount | Earnings |
| | (WON) | (persons) | (piece) | (piece) | (WON) | (WON) |
| Selling | 50,000 | 1 | 1 | 1 | 50,000 | +20,000 |
| price | 48,000 | 2 | 3 | 4 | 192,000 | +72,000 |
| | 45,000 | 4 | 4 | 8 | 360,000 | +120,000 |
| | 40,000 | 45 | 50 | 58 | 2,320,000 | +580,000 |
| | 35,000 | 130 | 150 | 208 | 7,280,000 | +1,040,000 |
| Cost | 30,000 | 120 | 200 | 408 | 12,240,000 | 0 |
| | 28,000 | 15 | 20 | 428 | 11,984,000 | −856,000 |

It should be noted that the present invention is not limited to one form of currency. Therefore, while the present example uses South Korean won, any currency (e.g., U.S. dollars) can be similarly used. Currency conversion may be implemented as a part of the present invention.

In this example, a total of four buyers may register at purchase prices of 45,000 won or greater, as indicated by the “number of buyers” column in Table 1. When a seller completes a sale, the higher-price-accumulated purchase quantity may be sold at the determined selected purchase price. For example, if a seller chooses to sell an accumulated quantity of 8 goods at 45,000 won, the goods would be sold at 45,000 won to the seven buyers who registered at purchase prices of 45,000 (4 units), 48,000 (3 units), and 50,000 (1 unit) won. Therefore, buyers registering to buy at a higher purchase price may end up buying at a purchase price lower than the purchase price at which they registered.

Any number of sellers can make a competitive selling offer according to a most profitable sales strategy. For example, a seller having a small quantity of secured goods can offer to sell at a purchase price over 45,000 won so as to have a high profit for the small quantity of goods, and a seller who needs funds promptly can offer to sell at a purchase price lower than production cost. Alternatively, a seller may “cherry pick” as described above.

Referring to Table 1, the “Purchase Total Amount” shows the amount that a seller would receive if that seller were to sell a higher-price-accumulated quantity of goods at the corresponding recommended purchase price. “Earnings” shows the profit above the lowest cost (e.g., production cost) that a seller would receive if the seller were to sell the higher-price-accumulated quantity of goods at the corresponding recommended purchase price.

Meanwhile, buyers compete for the lowest price that a seller is likely to select. This phenomenon is a natural free market competition principle and induces the seller to sell at a price acceptable to competing buyers.

Referring now to Tables 2 and 3, a generalized example of the present invention is illustrated with reference to a specific good G being sought by a plurality of buyers seeking to make purchases and providing purchase buying offer registration information. The purchase offer registration information includes a number recommended purchase prices P and recommended purchase quantities Q for the goods G. The received recommended purchase quantity A is added to a recommended purchase quantity Qᵢ of a recommended purchase price Pᵢ, where 1≦i≦n, and where Pᵢ is a higher price than Pᵢ+1. Pᵢ is the same recommended purchase price as the received recommended purchase price P among purchase prices between P₁˜Pₙ for the goods G. The higher-price-accumulated recommended purchase quantity AQᵢ =Σ₁¹Qₘ is updated as a result of adding the received recommended purchase quantity A. As set forth herein, index i is used to indicate the ith price, Pᵢ and its corresponding entries. The index n corresponds to the total number of prices or the nth price, Pn. Index m is a placeholding index used for calculations involving variable index i's.

TABLE 2
Before addition of A

| | | | | Higher-price- | | |
|---|---|---|---|---|---|---|
| | | Number | Recommended | accumulated | Purchase | Purchase |
| Purchase | Recommended | of | purchase | purchase | total | total |
| price | purchase price | buyers | quantity | quantity | amount 1 | amount 2 |
| Higher | P₁ | B₁ | Q₁ | AQ₁ | TA(1)₁ | TA(2)₁ |
| price | . . . | . . . | . . . | . . . | . . . | . . . |
| | Pᵢ₋₁ | Bᵢ₋₁ | Qᵢ₋₁ | AQᵢ₋₁ | TA(1)ᵢ₋₁ | TA(2)ᵢ₋₁ |
| | Pᵢ | Bᵢ | Qᵢ | AQᵢ | TA(1)ᵢ | TA(2)ᵢ |
| | Pᵢ₊₁ | Bᵢ₊₁ | Qᵢ₊₁ | AQᵢ₊₁ | TA(1)ᵢ₊₁ | TA(2)ᵢ₊₁ |
| | . . . | . . . | . . . | . . . | . . . | . . . |
| Lower | Pₙ | Bₙ | Qₙ | AQₙ | TA(1)ₙ | TA(2)ₙ |
| price | | | | | | |

TABLE 3
After addition of A

| | | | | Higher-price- | | |
|---|---|---|---|---|---|---|
| | | Number | Recommended | accumulated | Purchase | Purchase |
| Purchase | Recommended | of | purchase | purchase | total | total |
| price | purchase price | buyers | quantity | quantity | amount 1 | amount 2 |
| Higher | P₁ | B₁ | Q₁ | AQ₁ | TA(1)₁ | TA(2)₁ |
| price | . . . | . . . | . . . | . . . | . . . | . . . |
| | Pᵢ₋₁ | Bᵢ₋₁ | Qᵢ₋₁ | AQᵢ₋₁ | TA(1)ᵢ₋₁ | TA(2)ᵢ₋₁ |
| | Pᵢ | Bᵢ + 1 | Q₁ + A = Qᵢ′ | AQᵢ′ | TA(1)ᵢ′ | TA(2)ᵢ′ |
| | Pᵢ₊₁ | Bᵢ₊₁ | Qᵢ₊₁ | AQᵢ₊₁′ | TA(1)ᵢ₊₁′ | TA(2)ᵢ₊₁ |
| | . . . | . . . | . . . | . . . | . . . | . . . |
| Lower | Pₙ | Bₙ | Qₙ | AQₙ | TA(1)ₙ | TA(2)ₙ |
| price | | | | | | |

Purchase offer registration information is provided to at least one seller, where the purchase offer registration information includes higher-price-accumulated purchase quantities AQ₁, AQ₂, . . . AQₙ for the corresponding recommended purchase prices P₁, P₂, . . . and Pₙ. for the goods G.

Additionally, it is desirable that the purchase offer registration information further includes each purchase total amount, TA(1)ᵢ=Σ₁ⁱPₘ×Qₘ, and/or TA(2)=Pᵢ×AQᵢ, of all the recommended purchase prices. Referring to Table 2, TA(2)ᵢ shows the amount that a seller would receive if the seller were to sell the higher-price-accumulated quantity AQᵢ of goods at the corresponding recommended purchase price Pᵢ.

At least one seller selects a recommended purchase buying price at which the seller will sell the higher-price-accumulated purchase quantity of goods. The transaction is then confirmed between the seller and all the buyers, where the buyers are related to the higher-price-accumulated purchase quantity selected by the seller.

Having set forth above the basic operation of the bi-directional auctioning system of the present invention, system and logical architecture are given in detail, below.

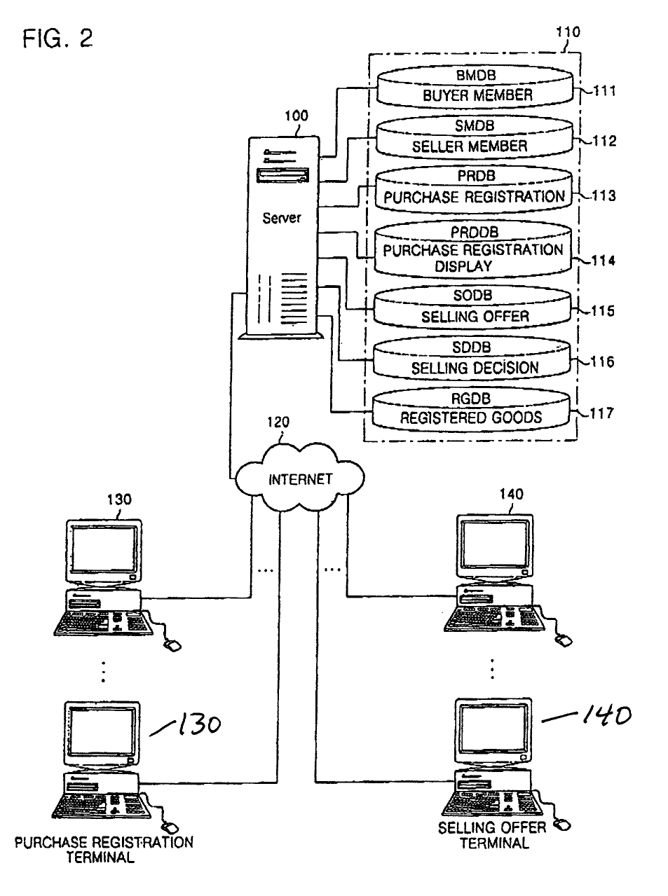

FIG. 2 shows a configuration of a bi-directional auctioning apparatus of the present invention.

A bidirectional auctioning apparatus, or system, includes a server 100 with a processor to execute a bi-directional auction program and a storage means 110 where a database may be stored. The server 100 executes the bidirectional auction program by referring to, managing, or renewing various databases stored in the storage means 110.

Storage means 110 includes buyer member database BMDB, 111, seller member data base SMDB, 112, purchase registration data base PRDB, 113, purchase registration display data base PRDDB, 114, a selling offer data base SODB, 115, selling decision data base SDDB, 116 and registered goods data base RGDB, 117.

The bidirectional auctioning apparatus also includes terminals 130, 140, which are connected the server 100 through a computer network such as the internet 120, or otherwise. Terminals 130 and 140 may include any display output such as a personal computer, a notebook computer, a hand computer, an internet cellular phone, an internet television, or other networkable information appliance.

Purchase registration and a selling offer programs are installed in a purchase registration terminal 130 and a selling offer terminal 140, respectively. Both purchase and selling programs may be installed on the same terminal or may be chosen by selection at a web site. Such a website may avoid installation of any programs upon the terminals as the operations for buying and selling may be performed via web pages and web programming. The purchase registration and selling offer programs may be downloaded from the server 100 through the internet, or may be installed on a hard disk of terminals 130, 140 from a recording medium such as a distributed compact disc (CD).

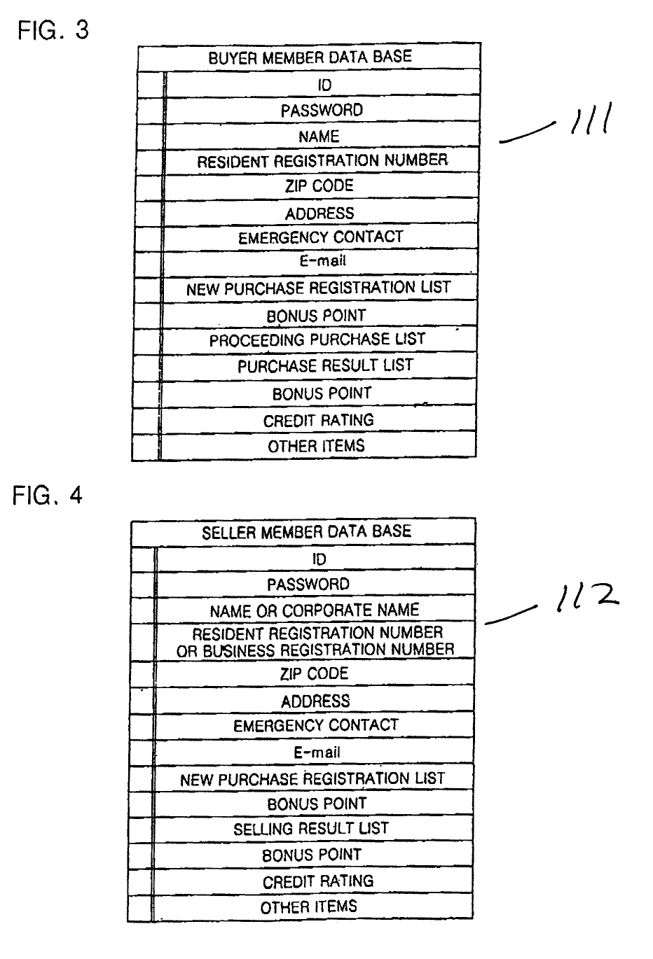

Referring to FIG. 3, buyer member data base 111 may include fields such as ID, password, name, resident registration number, zip code, address, emergency contact, E-mail, new purchase registration list, bonus points, current purchase registration list, purchase results list, bonus points, credit rating and other items.

The address field may include a home address or a recipient address. The emergency contact field may include a telephone number, mobile phone, or pager number.

The new purchase registration list field may include data for cases where a buyer registers buy bids for new goods not yet registered on the server 100, or registers a new purchase buy bid price not included in the purchase prices for goods already registered on the server 100. For example, if purchase buy bid prices registered to current goods are currently at 10,000 won and 9,000 won, the buyer can register 9,500 won as a new purchase buy bid price. This new price is held in the new purchase registration list field until posted.

A buyer can reserve bonus points according to the new purchase registration and substitute it for electronic money. A member of the bi-directional auction site may be awarded bonus points according to the frequency of site use or the number of transactions made on the site.

The ongoing purchase registration list is where a buyer lists purchase registration content for all goods that sellers are selling whose purchase term is not ended and whose sale is not decided. Therefore, a buyer can observe the progress of his own purchase registrations by referring to the ongoing purchase registration list. Of course, in the case where a buyer has multiple registrations of the same type of goods, the registrations are listed in table form, as shown in Table 1. An ongoing purchase registration situation is one in which a buyer participates (and is shown in the purchase result list) but whose purchase is not decided. A completed, or valid, purchase registration situation is one where the purchase is decided and the transaction is completed. A whole, or entire, selling registration situation includes both incompleted and completed purchase registrations, including the total amount of accumulated sales whose transactions have been completed. Therefore, each buyer can check and the status of purchases can be monitored according to his number of purchase registrations. As a reward, a manager of a server 100 can provide electronic money or bonus goods by awarding bonus points to the buyer according to purchase results by considering the total number of registrations, purchase hit rates, and total accumulated purchases.

The credit rating field is used for buyer management. The credit rating of a buyer is automatically determined and reflects the number of cancellations after purchase registration, the number of returned goods, and the purchase results of the corresponding buyer.

Referring now to FIG. 4, seller member database 112 includes an ID, password, name (corporate name or company name), resident registration number (business registration number), zip code, address, emergency contact, E-MAIL, new purchase registration list, bonus points, selling result list, credit rating, and other items.

Seller member database 112 is similar to buyer member database 111, with the addition of a new purchase registration list field adapter for seller-member (as opposed to buyer-member) management. The content of the new purchase registration list field includes such information as, purchase decision content, goods, quantity, total amount of sales related to a purchase price selected by a seller, and total amount of sales related to an accumulated purchase quantity.

Seller member management is accomplished by an automatically-determined credit rating. The credit rating is determined by considering the seller's number of new purchase registrations, bonus point reservations according to selling results, the rate of returned goods, the number of buyer dissatisfaction complaints, and the number of delivery accidents.

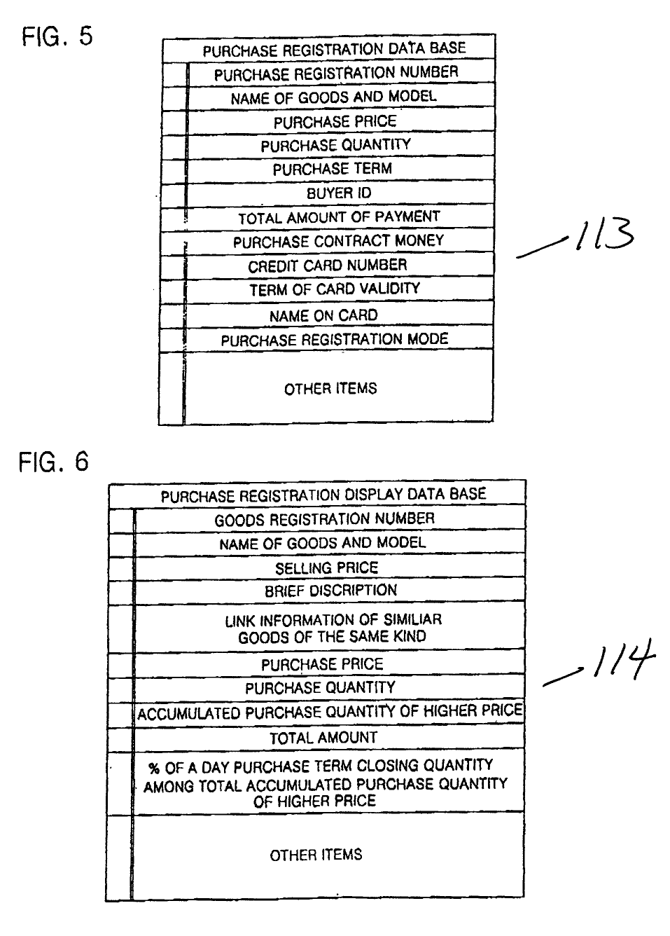

Referring to FIG. 5, purchase registration database 113 includes a purchase registration number, the names of goods and models, the purchase price, the purchase quantity, the purchase term, the buyer ID, the total amount of payment money, the purchase contract money, the credit card number, the card's expiration date, the name on the card, the purchase registration mode, and other items.

A purchase registration number is given automatically by the server 100 to the goods according to the order in which the purchase registration is received. The purchase registration number system uses different numbering systems to distinguish between the single registration mode and the plural registration mode. For example, the single registration mode and the plural registration mode are distinguished from each other by making the purchase registration number of the single registration mode as S-XXXXXX and the plural registration mode as M-XXXXXX (where the X's represent a unique purchase registration number). The single and plural registration modes are described in further detail hereinafter.

The purchase term is determined by the buyer, who may consider the amount of time available to make the purchase. The total amount of payment money is determined automatically by multiplying the purchase price by the purchase quantity. The purchase contract money is calculated automatically as a portion, for example 10%, of the total amount of payment money. Purchase contract money may not be repaid when a purchase registration is cancelled and may be repaid when the purchase term ends.

The purchase registration mode has a single registration mode and a plural registration mode. Where the registered goods of the same kind as the goods whose purchase price is to be registered by the buyer, either the single registration or plural registration can be selected. In a plural registration mode, the user can register a plurality of goods simultaneously using one purchase registration. In a single registration mode, the user can register by designating a product to a group of similar products. Mode selection information is stored in the purchase registration database.

Purchase registration display data is provided to terminals 130 and 140 in real time in order for a buyer and a seller to evaluate the purchase registration situation.

Referring to FIG. 6, purchase registration display database 114 includes a goods registration number, name of goods and model, selling price, brief description, link information of similar goods of the same kind, purchase price, purchase quantity, higher-price-accumulated purchase quantity of higher price, total amount of money, percentage of a day purchase term closing quantity among total accumulated purchase quantity, and other items.

Link information of similar goods of the same kind includes the registration number of goods registered as similar goods of the same kind.

Purchase quantity is a total purchase quantity registered at the corresponding purchase price, and higher-price-accumulated purchase quantity indicates the purchase quantity obtained by summing the total purchase quantity of goods having purchase prices above and equal to the corresponding purchase price.

The distribution of registered purchase prices for similar goods is generally concentrated around the prime cost, or an average cost, where there is a higher probability that the registered buy/purchase price will lead to a successful purchase. The number of registered purchase prices decreases rapidly as the purchase price approaches the retail (selling) price, and decreases rapidly as the price approaches zero most probably in a Gaussian manner. In other words, the purchase quantity for each purchase price can be depicted as a bell-shaped (Gaussian) curve. Because the goods comprising the accumulated selling quantity are all sold at the seller's highest selling price, the accumulated selling quantity draws a S-shaped curve having high slope around the prime cost. However, because the goods comprising the higher-price-accumulated purchase quantity are all sold at the lower selling price, the higher-price-accumulated purchase quantity draws an S-shaped curve having a high slope around the prime cost.

The total amount of money is calculated automatically by multiplication of the higher-price-accumulated purchase quantity and the purchase price. The total amount of money helps a seller determine the total amount of money a buyer needs for the purchase. Also, the buyer can determine the time at which to buy by viewing those purchase quantities whose purchase term ends at the close of day as a percentage to the total accumulated purchase quantity.

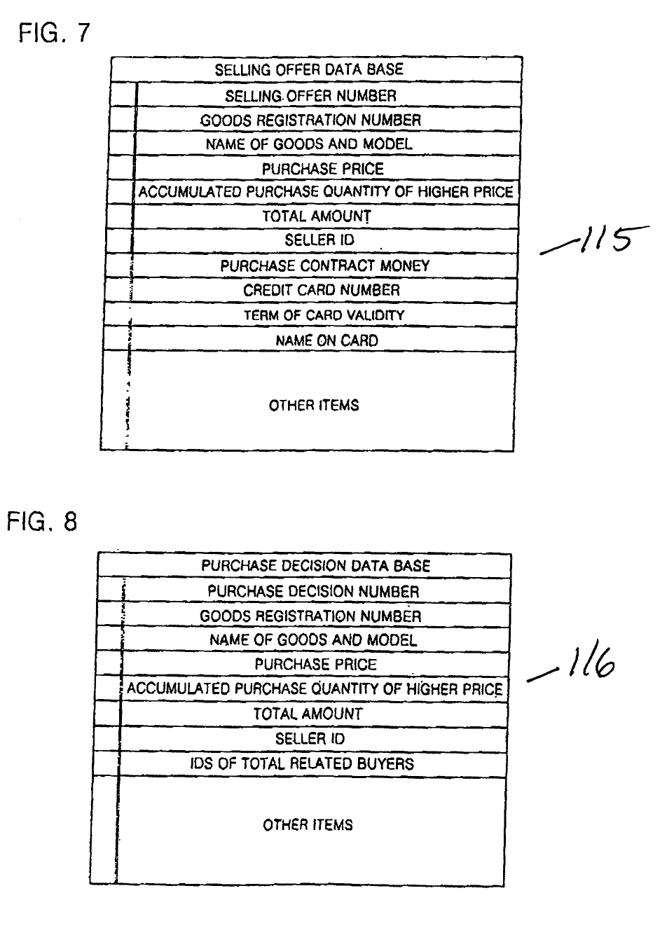

Referring to FIG. 7, the selling offer database 115 includes: the selling offer number, the goods registration number, the name of goods and model, the purchase price, the higher-price-accumulated purchase quantity of lower price, the total amount of purchase money, the seller ID, the purchase contract money, the credit card number, the card's expiration date, the name on the card, and other items.

Selling offer database 115 comprises data inputted when a seller registers through a terminal 130 or 140. The purchase contract money is calculated automatically as 10% of the total amount of purchase money. The purchase contract money is drawn from a seller's bank account using an inputted credit card number, and must be paid to an account of an operator of the present invention. Selling authority is given to the seller who pays first on an item up for bid. If the seller cancels the sale, the purchase contract money is not repaid but is distributed to the related buyers as an indemnity.

Referring to FIG. 8, purchase (selling) decision database 116 includes a purchase decision number, goods registration number, name of goods and model, purchase price, higher-price-accumulated purchase quantity, total amount, seller ID, IDs of total related buyers, and other items.

The purchase decision database is automatically created by reference to the selling offer database 115 and the purchase registration database 113. Purchases of all buyers of an item related to the selected purchase price and the higher-price-accumulated purchase quantity are decided by a selling offer.

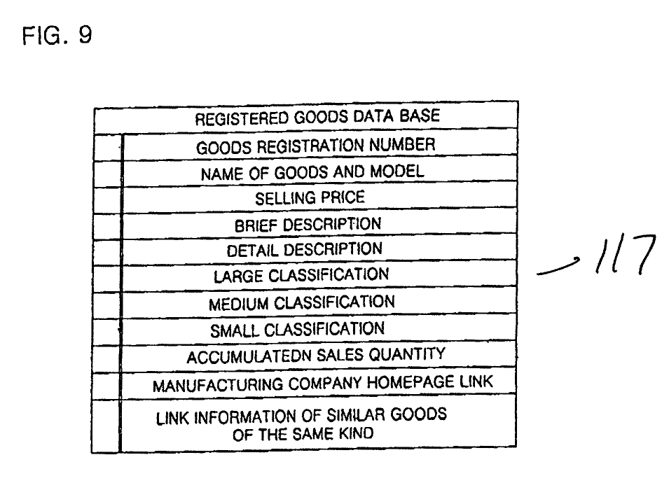

Referring to FIG. 9, the registered goods database includes a goods registration number, the name of goods and model, the selling price, a brief description, a detailed description, a large classification, a medium classification, a small classification, an accumulated sales quantity, a manufacturing company homepage link information URL (Uniform Resource Locators), and link information of similar goods.

The brief description of registered goods database includes a photograph of the goods, a representative specification, a simple presentation of the goods and the manufacturing company. The detailed description includes a concrete detailed description, structure, various photographs of goods, and includes the reliability and a narrow view of the goods. In case it is difficult to register concrete information for goods, the additional information of the goods can be added by an operator.

Link information of similar goods includes the registration number of similar goods of the same type.

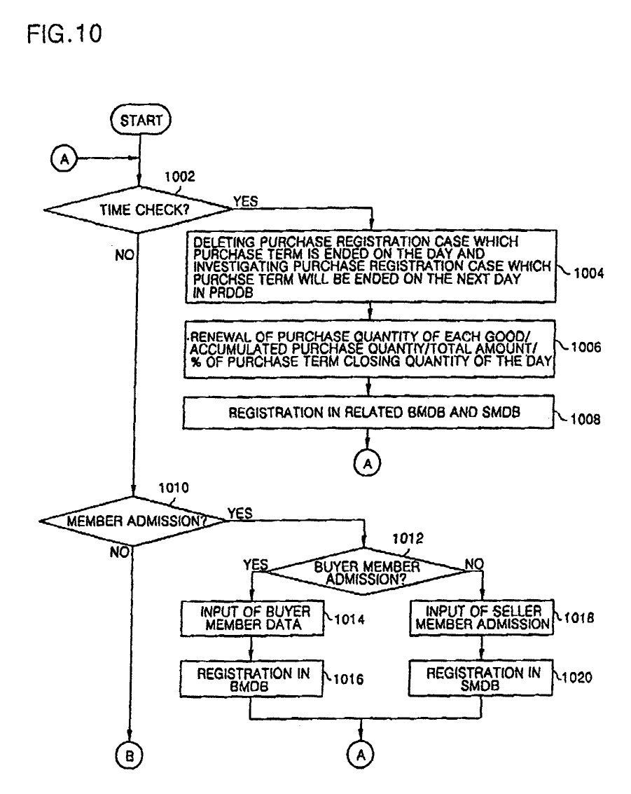

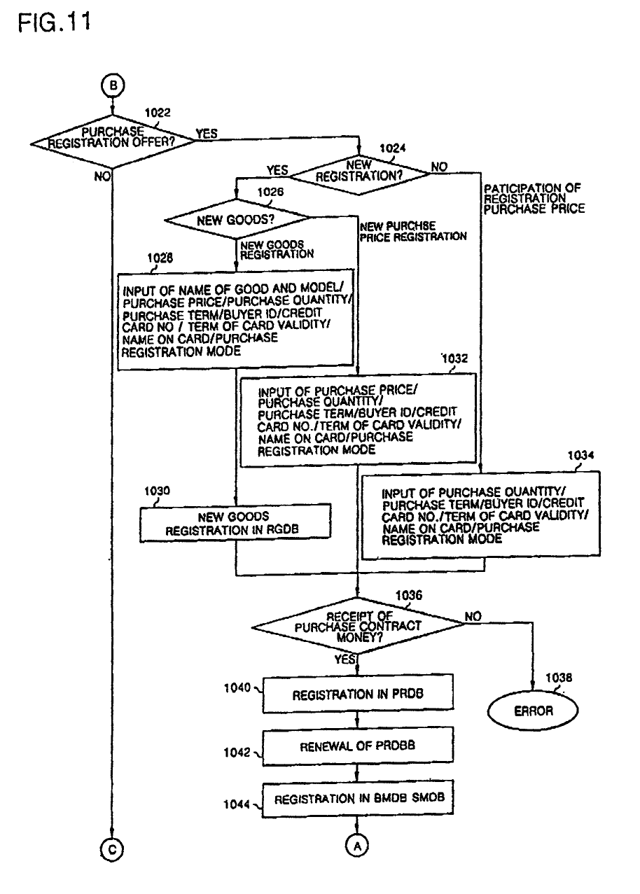

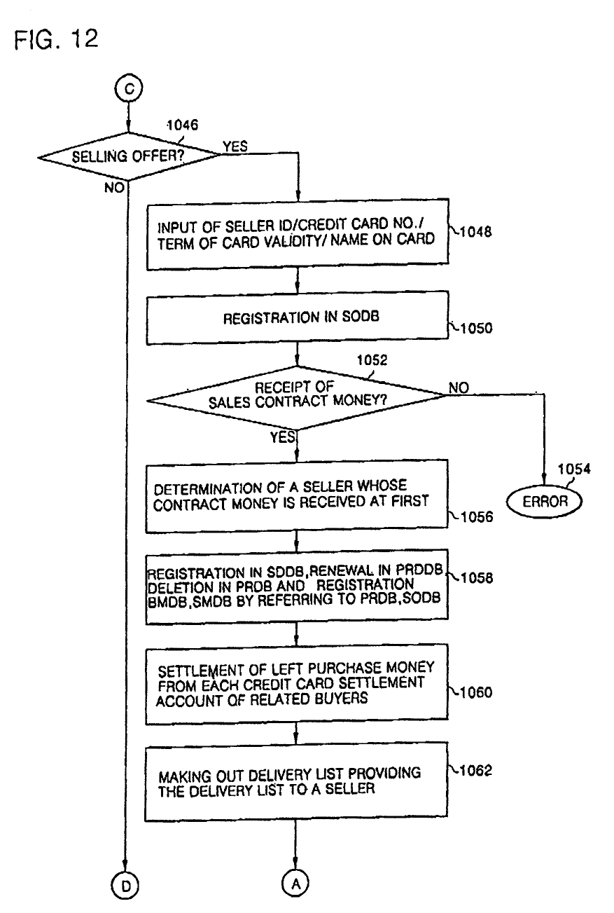

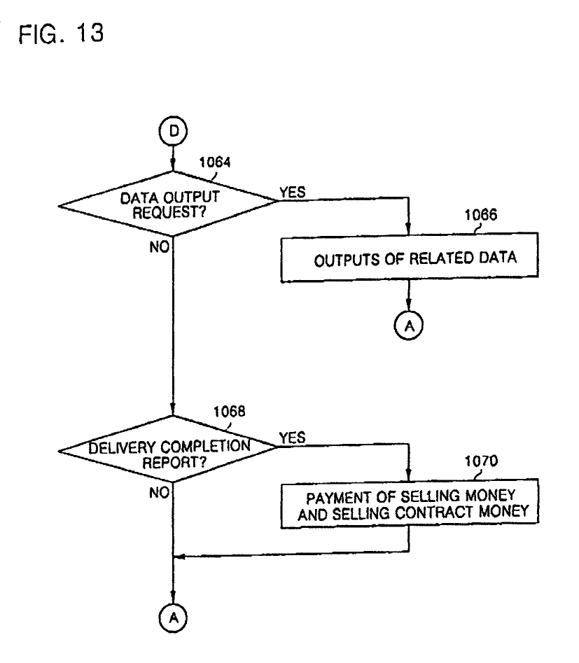

FIG. 10 shows a flow chart to illustrate the server operation in a bi-directional auctioning apparatus of the present invention. The process begins with server 100 checking for a specific time 1002. For example, 11:59 p.m. may be checked 1002 everyday. At the specific time, server 100 deletes purchase registration instances whose purchase term ended on that day, referring to PRDB 113. The server 100 also investigates 1004 the purchase quantity of the purchase registration instances whose selling term ends on the next day. Here, when deleting related purchase registrations, purchase registrations as to goods registered in plural mode are deleted simultaneously. The server 100 renews the purchase quantity, the higher-price-accumulated purchase quantity, and the total amount in the PRDDB 114 of each goods relating to the deleted purchase registration instance. The server 100 renews 1008 PRDDB 114 by calculating the percent (%) of the next day's purchase term closing quantity among the total accumulated purchase quantity for each type of good, and then registers 1008 the updates in BMDB 111 and SMDB 112. If the time check in step 1002 returns false, the server 100 checks 1010 whether there is an application for member admission from terminals 130, 100, and 140.

If there is an application for member admission present in step 1010, the server 100 checks 1012 whether it is an application for buyer member admission or for seller member admission. If it is an application for buyer member admission in step 1012, the server 100 inputs 1014 buyer member data and registers 1016 the inputted buyer member data in BMDB 111. If it is an application for seller member admission in step 1012, the server 100 inputs 1018 seller member data and registers 1020 the inputted seller member data in SMDB 112.

If there is no application for member admission in step 1012, the server 100 checks whether there is a buyer's purchase registration offer from terminals 130, 140.

In the case that there is a buyer's purchase registration offer in step 1022, the server 100 checks 1024 whether it is a new registration. If a new registration is found in step 1024, the server 100 checks 1026 whether it is a new goods registration. If it is a new goods registration in step 1026, the server 100 takes inputs 1028 of the name of goods and model, the purchase price, the purchase quantity, the purchase term, the buyer ID, the credit card number, the card's expiration date, the name on the card, and the purchase registration mode, and registers 1030 the inputted goods and model in the RGDB 117. If a new goods registration is not found in step 1026, the server 100 inputs and updates 1032 the purchase price, the purchase quantity, the purchase term, the buyer ID, the credit card number, the card's expiration date, the name on the card, and the purchase registration mode.

If it is not a new registration at step 1024, the server 100 takes input 1034 of the purchase quantity, the purchase term, the buyer ID, the credit card number, the card's expiration date, the name on the card, and the purchase registration mode.

The server 100 then checks 1036 for the receipt of money by requesting purchase contract money from a payment account of a credit card number inputted in steps 1030, 1032, or 1034. In the case that purchase contract money is not received in step 1036, the server 100 handles 1038 as an error. In the case that purchase contract money is received in step 1036, the server 100 registers 1040 purchase registration content inputted in PRDB, renews 1042 the related content of PRDDB, and registers 1044 purchase registration content in BMDB or SMDB of the related ID.

If there is no purchase registration offer in 1022, the server 100 checks 1046 whether there is a seller's selling offer to sell items for outstanding purchase registration offer. In the case that there is a selling offer from terminals 130 or 140 in step 1046, the server 100 takes as input 1048 the seller ID, the credit card number, the card's expiration date, and the name on the card, and registers 1050 the inputted selling offer data in the SODB 115.

Next, the server 100 requests 1052 the payment of sales contract money from the credit card settlement account of the inputted selling offer and checks whether it is received or not. In the case that sales contract money is not received at step 1052, the server 100 handles the case as an error 1054. In the case that sales contract money is received in step 1052, the server 100 determines 1056 the seller whose contract money is received first.

When a seller is determined, server 100 registers the information in the SDDB 116 by referring to the PRDB 113, SODB 115, and renewing or updating the purchase registration content of the determined sale in the PRDDB 114. Server 100 also deletes the purchase registration content in the PRDB 113, and registers 1058 the selling decision content of the confirmed sellers and confirmed buyers in the BMDB 111 and SMDB 112. Here, for the cases of the plural registration mode among each purchase registration case of the selected purchase price, the server 100 deletes all data in the purchase registration list of related similar goods of the same kind. Then, the server 100 settles 1060 the purchase money payment by receiving the remaining money, except the contract money of the purchase money, from each credit card settlement account of related buyers.

The server 100 creates a delivery list of all related buyers by referring to the BMDB 111 and provides 1062 the delivery list to the seller.

If there is not a selling offer in step 1046, the server 100 checks 1064 whether there is a data output request. If there is, the server 100 outputs 1066 related data by referring to the relevant database.

If there is no data output request at step 1064, the server 100 checks 1068 whether there is a delivery completion report, and when a delivery completion report is received, the server 100 pays 1070 the selling money and selling contract money of related buyers to a seller as settled purchase money by referring to the SDDB 116.

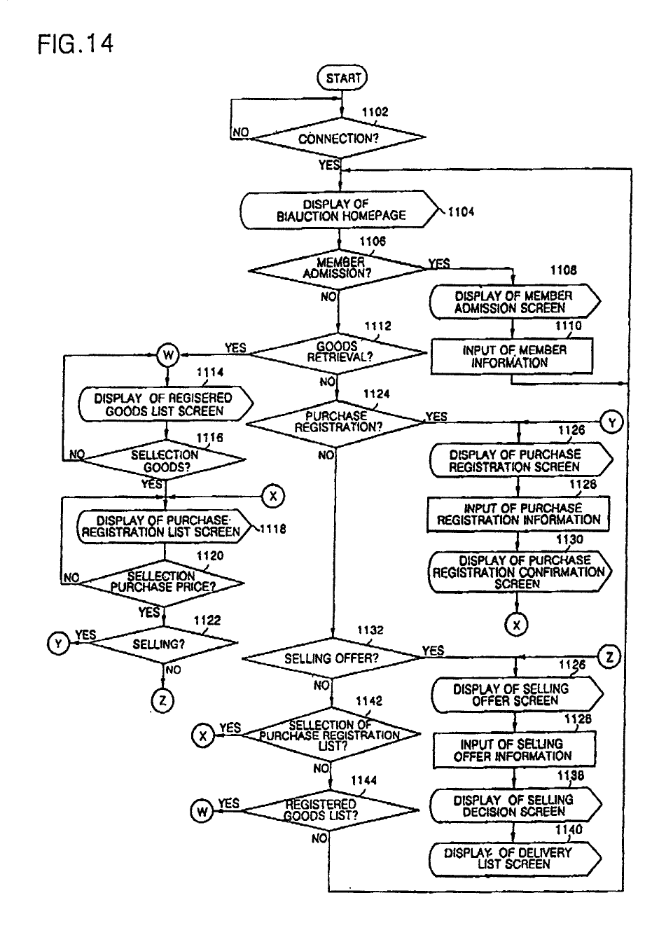

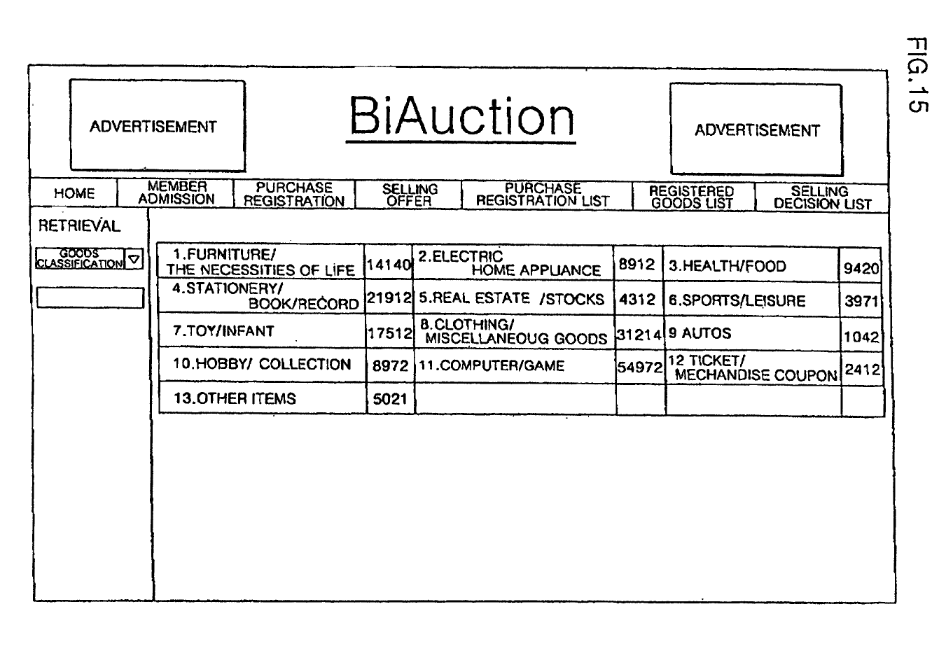

FIG. 14 is a flow chart illustrating the operation of terminals 130, 140 of a bi-directional auctioning apparatus of the present invention, and FIG. 15 through FIG. 24 show screen-state drawings.

Referring to FIGS. 14 and 15, in terminals 130 and 140, if a user clicks a bi-directional auction icon on a window start screen, a bidirectional auction program is executed. For example, a user can gain access to a bidirectional auction site through the internet via a web browser. The bidirectional auction program may either be local or remote to the user. At step 1102, if access is gained to a bidirectional auction site, the server 100 and terminals 130,140 are interconnected through the internet 120.

The server 100 provides a bi-directional auction homepage of FIG. 15 and displays a homepage screen on the terminal by the request of the terminal.

On the homepage screen of FIG. 15, there is a main menu including clickable links to: home, member admission, purchase registration, selling offer, purchase list, registered goods list, and selling decision list. On the left of the screen is a goods retrieval tool. The goods retrieval tool can perform retrieval using goods classifications or through character and number input such as goods name, goods registration number, purchase registration number, sale checking number, and purchase price. The center of the screen displays information indicating general classification names for goods retrieval and the number of purchase registration instances of each such classification. The displayed classification name is only one example, and various classifications and names thereof can be selected.

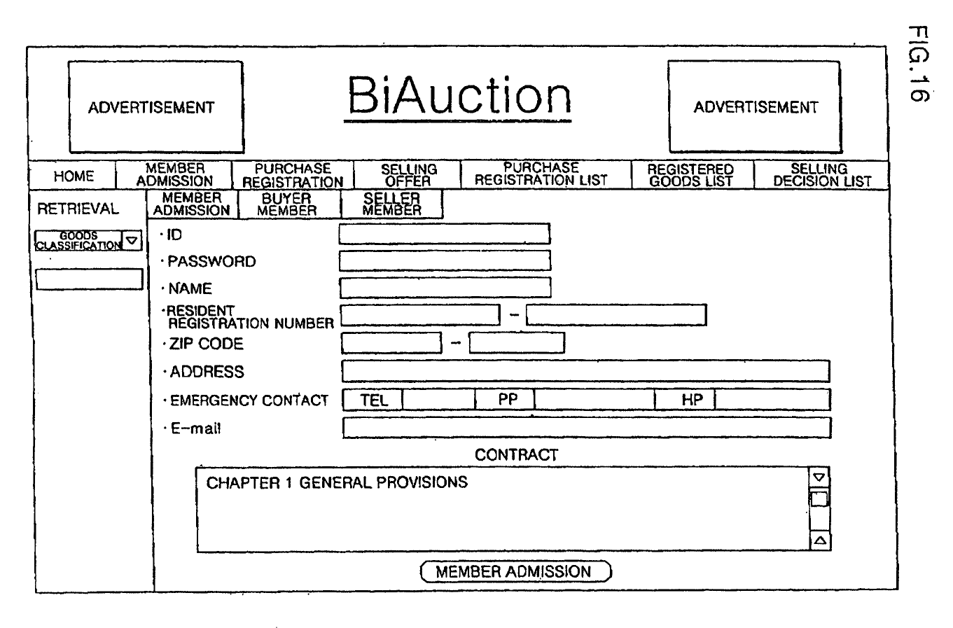

If the user clicks 1106 the “member admission” menu item on the homepage screen, a member admission screen of FIG. 16 is displayed 1108. If the user clicks “buyer member” on the member admission screen of FIG. 16, a buyer member input window is displayed as shown. If the user clicks “seller member”, a seller member input window, similar to the buyer member input window, is displayed. If the user inputs member information in the input fields of FIG. 16 and clicks the “member admission” button on the screen, the inputted member information is sent to the server 100 and registered in the BMDB 111 or SMDB 112 of database 110, as appropriate.

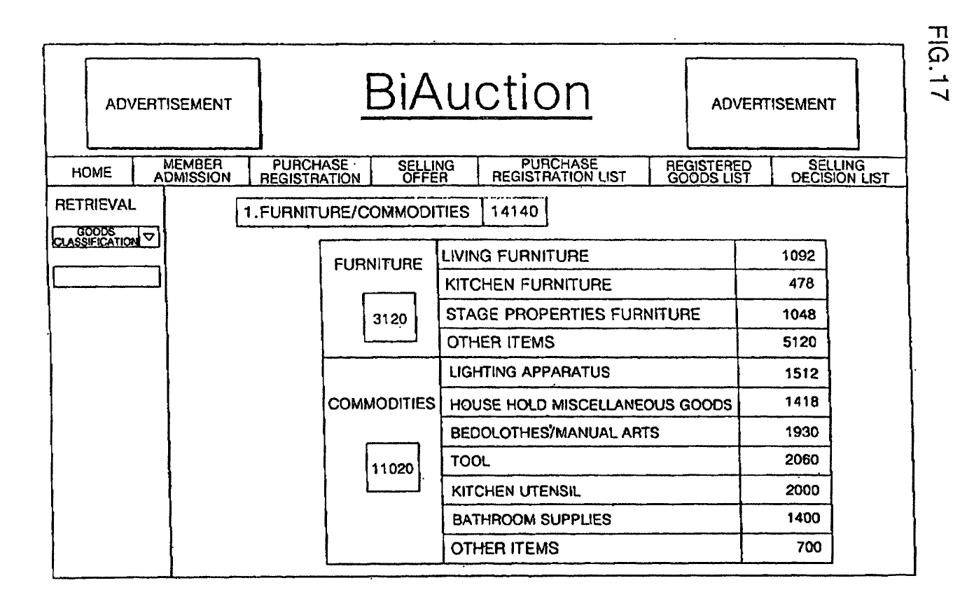

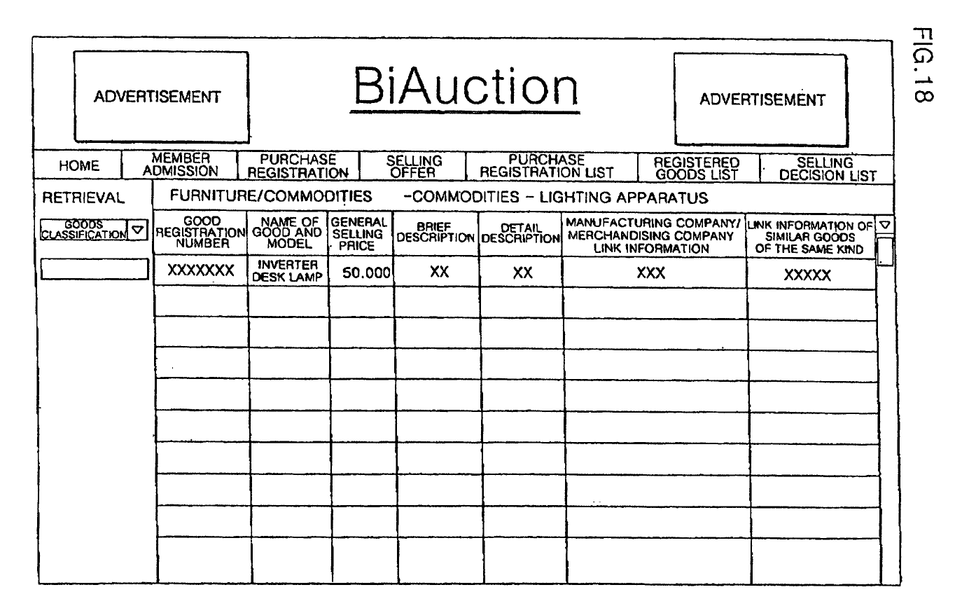

Referring again to FIGS. 14 and 15, if member admission is not selected at step 1106, the server 100 checks 1112 whether there is a goods retrieval command. A goods retrieval command is inputted by clicking one category among the general classification of goods displayed on the screen or by using the retrieval tool on the left of the screen. If the user clicks “1. furniture/commodities” among the large classification in FIG. 15, the small and medium scale classification screens of FIG. 17 are displayed. If the user selects “lighting apparatus” on the small and medium classification screen of FIG. 17, a registered goods list screen of FIG. 18 is displayed 1114.

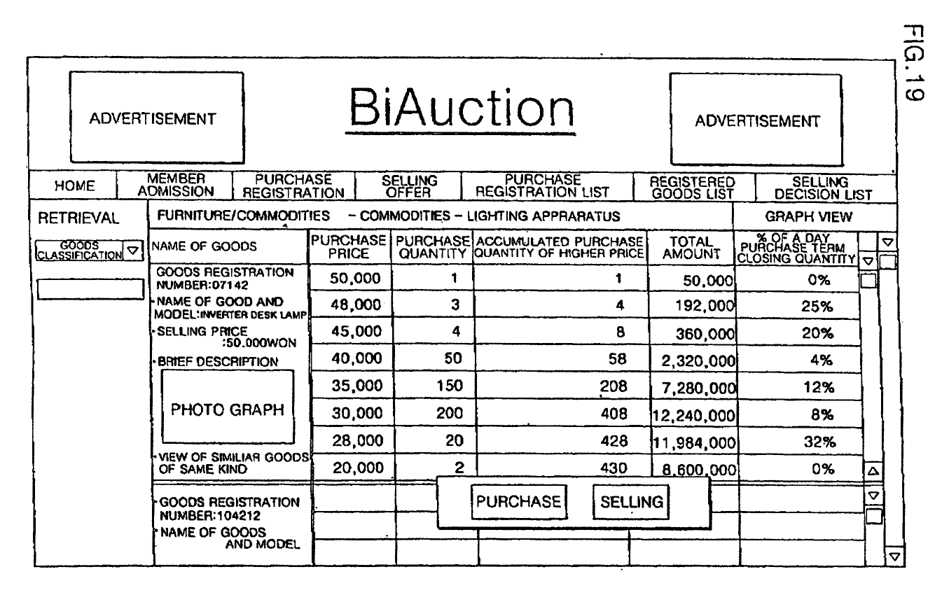

On FIG. 18, if the user clicks 1116 on a desired good, for example “inverter desk lamp” on the screen displayed at step 1114, a purchase registration list screen of an inverter desk lamp of FIG. 19 is displayed 1118.

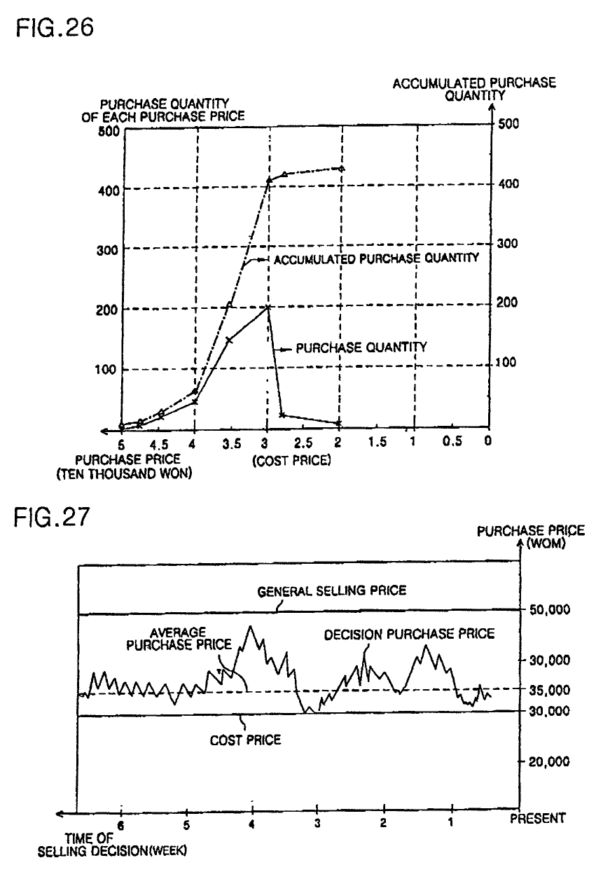

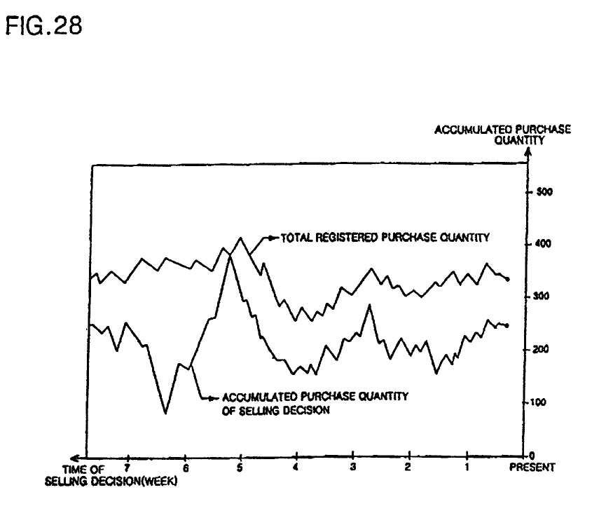

If the user clicks “graph view” on the screen of FIG. 19, one can see the analysis graphs of FIG. 26 through FIG. 28. For example, one can see a graph depicting purchase quantity and accumulated purchase quantity as a function of purchase price (FIG. 26), a graph depicting decision purchase price as a function of time (FIG. 27), and a graph of decided accumulated purchase transaction amounts as a function of selling decision data and time (FIG. 28). A buyer or a seller may determine a desired purchase price by referring to the above graphs.

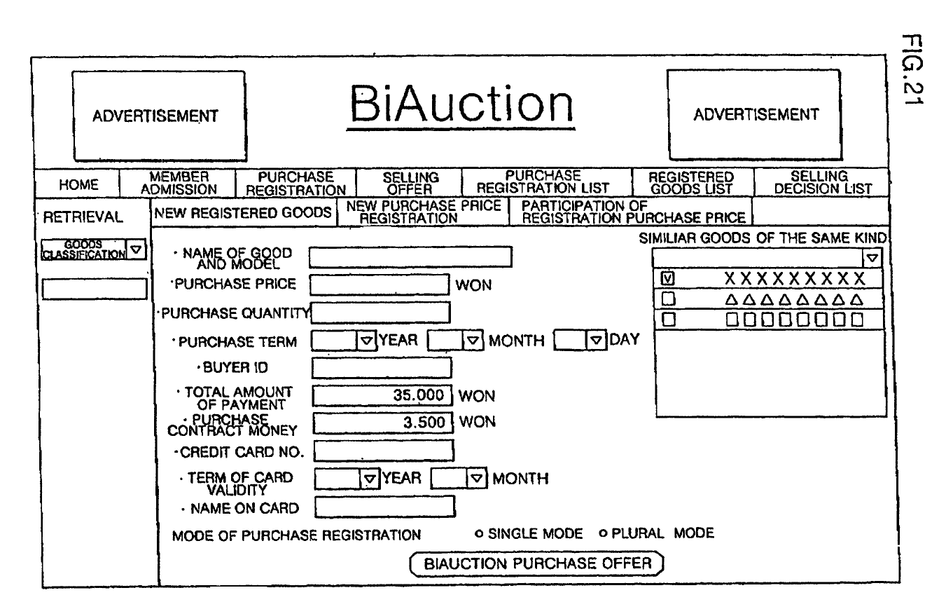

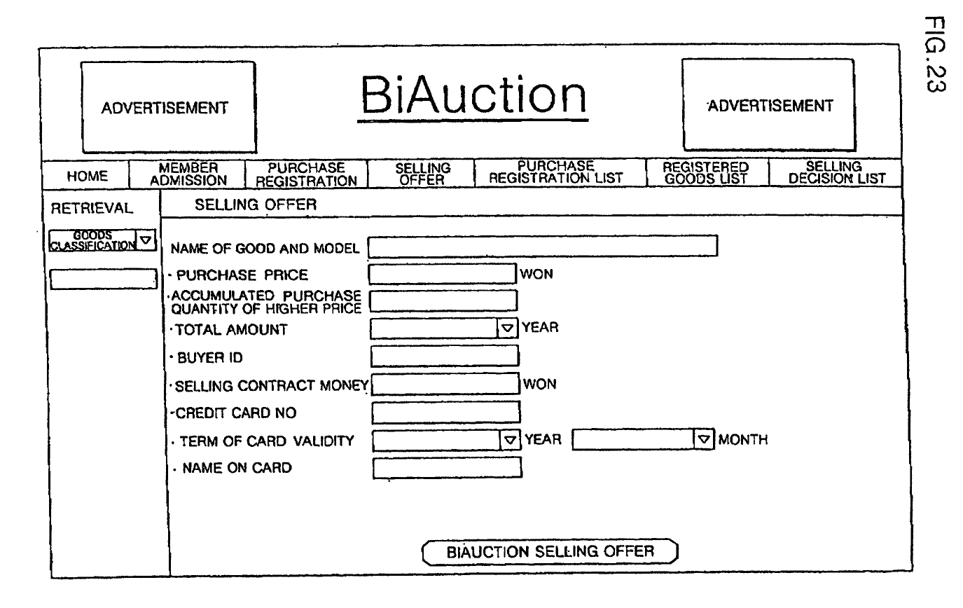

On the screen of FIG. 19, if the user clicks 1120 on one of the purchase prices, a selection window for selecting either purchasing or selling is displayed on the screen. The screen is shown near the bottom of FIG. 19. If the user selects “purchase” on the displayed selection window, the purchase registration screen of FIG. 21 is displayed 1126. If the user selects “selling” on the selection window, the selling offer screen of FIG. 23 is displayed 1134.

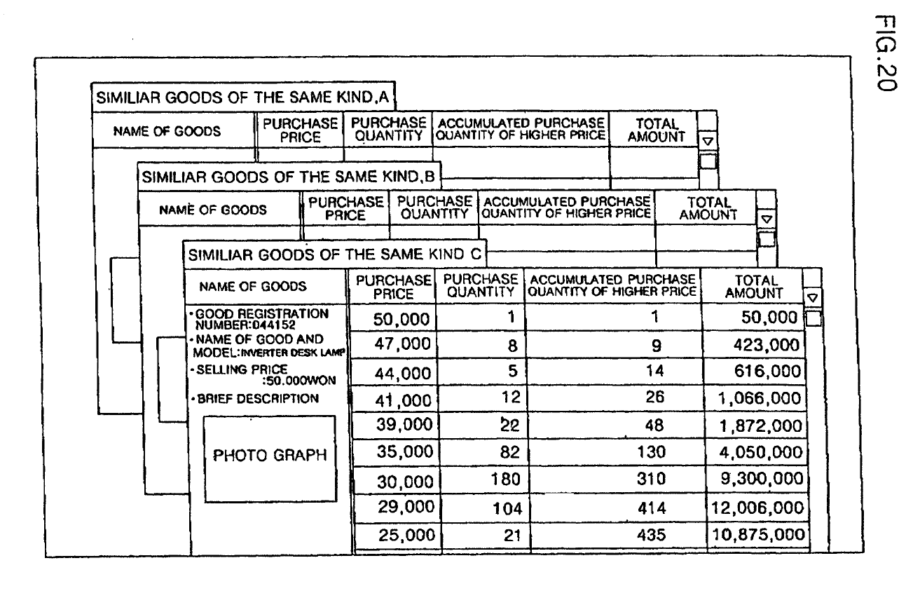

If the user clicks “view similar goods of the same kind” on the screen of FIG. 19, the purchase registration lists of all the similar goods of the same kind is displayed as shown in FIG. 20. For example, one can see the purchase registration list of inverter desk lamp B and inverter desk lamp C. Therefore, one can look at the purchase registration situation for similar goods of the same kind.

If the user clicks 1124 the “purchase registration” menu item on the main screen of FIG. 15, the purchase registration screen of FIG. 21 is displayed. If the user clicks 1132 the “selling” offer menu item on the main menu of FIG. 15, the selling offer screen of FIG. 23 is displayed. If the user clicks 1142 the “purchase registration” list menu item on the main screen of FIG. 15, the purchase registration list screen of step 1118 is displayed (FIG. 19). Of course, because in this case there is no goods selection, a sequential listing of purchase registration numbers is displayed. If the user clicks 1144 the “registered goods list” menu item on the main screen of FIG. 15, the registered goods list screen of step 1114 is displayed. Again, because there is no category selection, a sequential listing of registered goods is displayed.

In the case that a desired good is not registered at step 1114, the user selects the “purchase registration” menu item of FIG. 15 to move to the purchase registration screen of FIG. 21, and then clicks on the “purchase registration” menu item on the screen of FIG. 21.

On the purchase registration screen of FIG. 21, if the user clicks “new registered goods” on the screen to register new goods, all input fields are displayed as blank (without data). The column of similar goods of the same kind is displayed as a blank column because there are no established similar goods of the same kind.

If the user clicks “new purchase price registration”, the name and model of recorded goods, and a list of registration numbers for these goods are displayed in the appropriate input fields.

If the user clicks “participation of registration purchase price”, the name and model of recorded goods, a list of the corresponding registration numbers, and a purchase price selected in advance are displayed in input fields.

A buyer inputs 1128 purchase registration information in the appropriate input fields (including the name/model as well as the price). If the user inputs purchase quantity, the total amount of payment money and the purchase contract money are calculated automatically and displayed in the corresponding input field.

During the purchase registration mode, the user selects either the single registration mode or the plural registration mode. If the user selects the plural registration mode, plural registration is enabled. The selection of similar goods of the same kind can then be accomplished by checking the goods registration number in a drop-down selection box arranged on the right hand side of the window. If the user clicks each goods registration number, the user can see a related purchase registration list (FIG. 19). The user can perform a purchase price registration on the purchase registration list screen of each similar goods of the same kind.

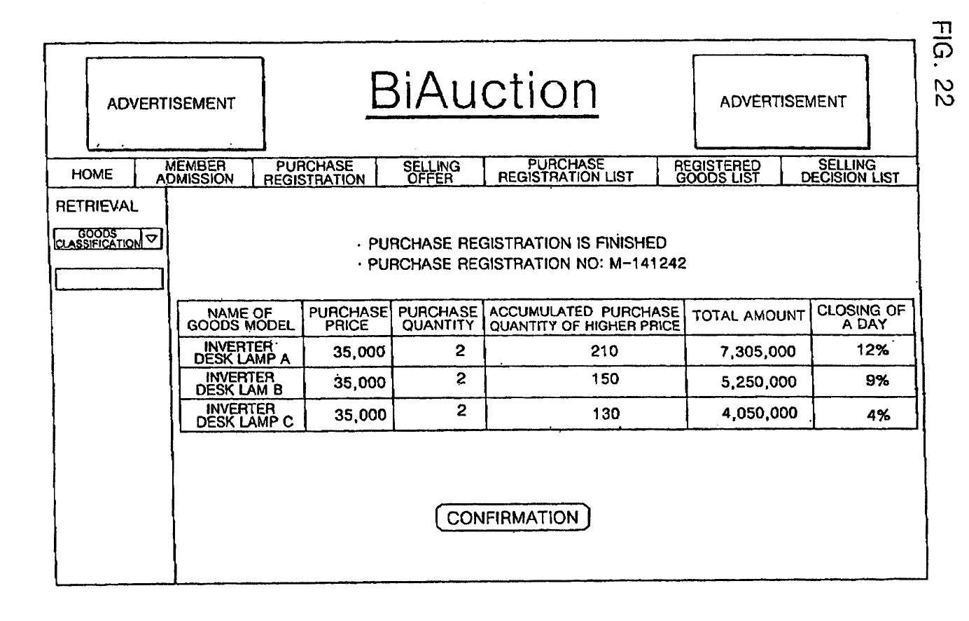

Inputted purchase registration information is transmitted to server 100 through the internet 120, and the transmitted purchase registration information is registered in the various related databases. Then, a purchase registration confirmation screen of FIG. 22 is displayed 1130. The user checks the accuracy of the purchase registration number and registered content and, if they are accurate, then clicks a confirmation button on the purchase registration confirmation screen. The purchase registration procedure is then completed.

In the case of a plural registration mode, all purchase registration content for the buyer's plurality of registrations is displayed. For example, FIG. 22 shows the case of a plural registration of similar goods of the same kind of 3 different companies. That is, the example shows the display of the purchase registration content of inverter desk lamp B and C, which are similar goods of the same kind as inverter desk lamp A.

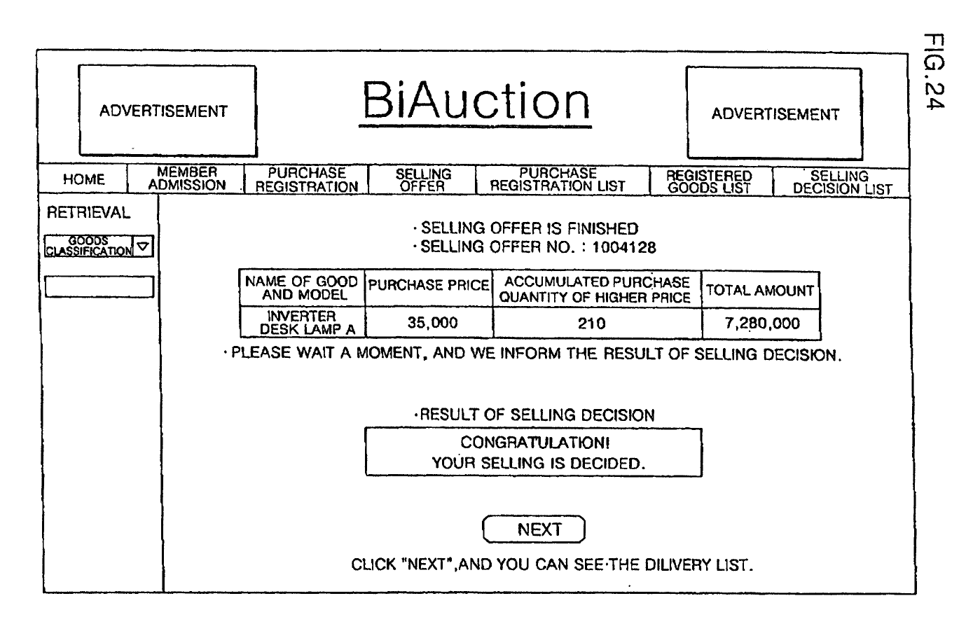

At step 1126, information related to the purchase price selected by a seller is displayed in the input fields on the purchase offer screen of FIG. 22. Such information may include the name of goods and model, the purchase price, a higher-price-accumulated purchase quantity, the total amount, and the sales contract money. A purchase offerer need only input 1128 the seller ID, the credit card number, the card's expiration date, and the name on the card. After inputting, if the user clicks a bi-directional auction selling offer button on the bottom of the screen, the selling offer confirmation screen of FIG. 23 is displayed 1138. Inputted selling offer information is sent to the server 100 through the internet 120, and the server 100 processes the inputted selling offer information and registers the processed offer information in a related database. The server 100 then processes the receipt of sales contract money from the credit card settlement account of a seller. If the purchase contract money is received and the sale is determined, a selling confirmation result such as the “Congratulations” message shown in FIG. 24 is displayed.

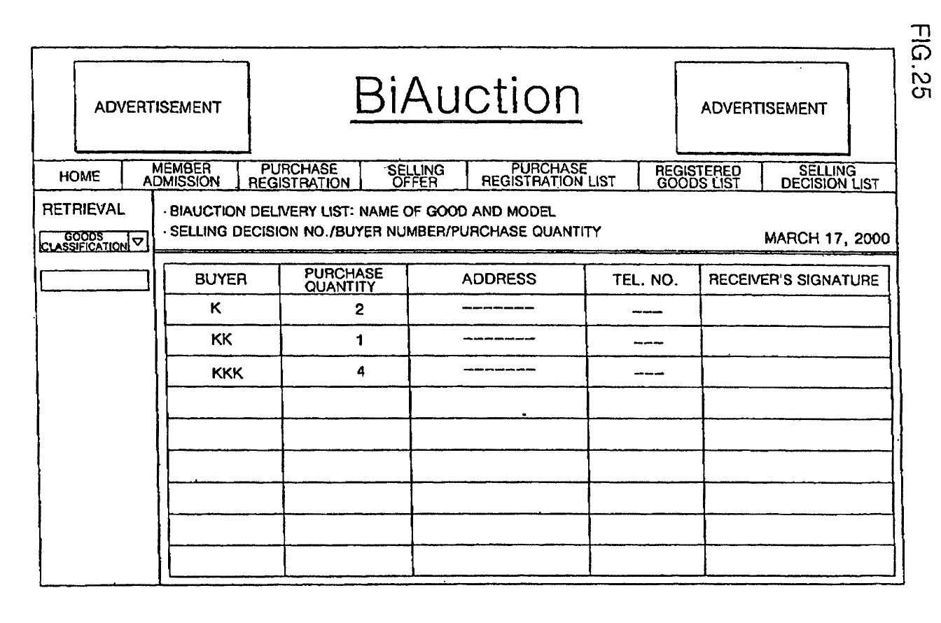

If the user clicks the “next” button on the screen after the selling confirmation result is displayed, a delivery list screen of FIG. 25 is displayed 1140. Contents of the delivery list include the names of all buyers related to the purchase price selected by the seller, the names of all buyers related to all higher purchase prices, purchase quantity, address, and an emergency contact. The seller prints the delivery list and delivers goods to each buyer on the list. The seller then provides a receipt confirmation signature to a bi-directional auction operator after the sales money and sales contract money, minus commission, are settled.

One alternative embodiment of the present invention is the restricting case where only a seller who can supply the whole quantity of higher-price-accumulated purchase quantity can make an offer to sell. This secures purchase quantities of lower price in order to induce a large number of sales.

Alternatively, it is possible to offer sales of a portion of the higher-price-accumulated purchase quantity, even when a seller cannot secure the whole quantity. In this case, the buyers are determined, and the transaction is consummated, according to the purchase registration ranking among the total buyers related to the selected purchase price and higher purchase prices. The other buyers outside the ranking are maintained as they are in their current ranking state. The use of this method induces competition among sellers for the purchase registrations of buyers.

In the present situation, a credit card settlement method is described, but other settlement methods such as an electronic bank transfer or electronic money such as cyber money or e-money are possible.

Also, the above-described example illustrates the display of the closing percentage of that day to help establish a sales strategy. It is also possible to show the change in rate of purchase registrations per hour, the purchase quantity corresponding to each purchase price, and the higher-price-accumulated purchase quantity in the form of various graphs. Moreover, it is preferable to show analysis data or an analysis graph for analyzing the purchase registration situation of a buyer to determine sales strategy.

As described hereinabove, the present invention can obtain the effect of mass sales and the effect of reducing purchase prices due to mass sales simultaneously by allowing sellers to make selling offers competitively according to his or her own sales strategy, and by opening information to a number of sellers through the internet. Such information can include various purchase prices for the same goods, the purchase quantity according to each purchase price, the higher-price-accumulated purchase quantity, and the total sales. Also, sellers in groups and buyers in groups participate in purchases and sales competitively because buyers tend to participate at a purchase price having a high possibility of transaction consummation so that the selling price is determined at a lower price. Therefore, it is possible to embody a complete free market competition principle on the internet by allowing the purchase price to be determined synergistically through mutual competition.

The present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the present invention has been described with reference to a preferred embodiment or to particular embodiments, it will be understood that various changes and additional variations may be made and equivalents may be substituted for elements thereof without departing from the scope of the invention or the inventive concept thereof. In addition, many modifications may be made to adapt a particular situation or material to the teachings of the invention without departing from the essential scope thereof. Therefore, it is intended that the invention not be limited to particular embodiments disclosed herein for carrying it out, but that the invention includes all embodiments falling within the scope of the appended claims.

What is claimed is:

1. A method for bi-directionally auctioning using a computer network, the steps comprising:
accepting as input a plurality of purchase prices and purchase quantities for an item;
displaying higher-price-accumulated purchase quantities for respective purchase prices, said higher-price-accumulated purchase quantity being obtained by summing purchase quantities at a first purchase price and all higher purchase prices;
accepting as input a selection of a seller, said selection being a higher-price-accumulated purchase quantity for a corresponding purchase total amount; and
consummating a transaction between said seller and all buyers associated with said selected higher-price-accumulated purchase quantity.

2. A method for bi-directionally auctioning using a computer network the steps comprising:
accepting as input into a computer a description of an item, a purchase price, a purchase quantity, and a purchase contract deposit;
displaying on said computer a plurality of purchase prices for said item, a purchase quantity for each purchase price, and a higher-price-accumulated purchase quantity for each purchase price, said higher-price-accumulated purchase quantity being obtained by summing the purchase quantities at a first purchase price and all higher purchase prices for said item;
authorizing a sale of one of said higher-price-accumulated purchase quantities to a seller who first selects a sale purchase price corresponding to said one of said higher-price accumulated purchase quantities; and
confirming said sale between said seller and all buyers corresponding to said sale purchase price and higher prices offered by said buyers.

3. The method of claim 2, wherein said steps of accepting as input into a computer includes:
accepting purchase term information.

4. The method of claim 2, wherein said step of displaying on said computer further includes:
displaying a total amount for each purchase price, said total amount obtained by multiplying each purchase price times a corresponding higher-price-accumulated purchase quantity.

5. The method of claim 2, wherein said step of displaying on said computer further includes:
displaying fluctuation of higher-price-accumulated purchase quantity over time.

6. The method of claim 2, wherein said step of displaying on said computer further includes:
displaying purchase prices from higher price to lower price.

7. The method of claim 2, wherein said step of authorizing on said computer further includes:
determining an order in which purchase contract money is deposited.

8. The method of claim 7, wherein said purchase contract money is a portion of a total amount, said total amount determined by multiplying a selected purchase price and a corresponding higher-price-accumulated purchase quantity.

9. An apparatus for bi-directionally auctioning using a computer network, the apparatus comprising:
a storage device storing a bi-directional auction program;
a processor configured to execute said bi-directional auction program, said bi-directional auction program directing said processor to:
accept a description of an item for auction with a purchase price, purchase quantity, and a related purchase contract deposit as input into a computer;
display on said computer a plurality of purchase prices for said item, a purchase quantity for each purchase price, and a higher-price-accumulated purchase quantity for each purchase price, each of said higher-price-accumulated purchase quantities being obtained by summing all purchase quantities at a first purchase price and all higher purchase prices for said item;
authorize a sale of one of said higher-price-accumulated purchase quantities to a seller who first selects a purchase price corresponding to said one of said higher-price-accumulated purchase quantities; and
confirm said sale between said seller and all buyers having purchase prices at or above said selected purchase.

10. The apparatus of claim 9, wherein said storage device includes a member database, a purchase registration database, a purchase registration display database, a selling offer database, a selling decision database and a registered goods database.

11. A method for conducting a bi-directional auction using a computer network, the steps comprising:
accepting as input into a computer a description of an item for auction with a purchase price, a purchase quantity, and a purchase contract deposit amount;
displaying on said computer a plurality of purchase prices for said item, a purchase quantity for each purchase price, and a higher-price-accumulated purchase quantity for each purchase price, such higher-price-accumulated purchase quantities being obtained by summing all purchase quantities at a first purchase price and all higher purchase prices for said item;
authorizing a sale of a portion of a higher-price-accumulated purchase quantity to a seller who first selects a purchase price corresponding to said portion of the higher-price-accumulated purchase quantity; and
confirming said sale between said seller and all buyers who correspond to said portion of the higher-price-accumulated purchase quantity.

12. The method of claim 1 1, wherein said step of authorizing a sale includes:
said buyers of said item are determined by a sequence of purchase registration numbers among all buyers of said item associated with said purchase price corresponding to said portion.

13. The method of claim 1 1, wherein said step of displaying on said computer further comprises:
displaying purchase term information and total amount information, said total amount information obtained by multiplying a purchase price by a the higher-price-accumulated purchase quantity.

14. The method of claim 11, wherein said step if displaying on said computer further comprises:
displaying purchase prices from higher price to lower price.

15. The method of claim 11, wherein said step of authorizing a sale further comprises:
determining a sequence of deposits for purchase contract monies.

16. A method for conducting a bidirectional auction using a computer network, the steps comprising:
receiving a purchase price, a purchase quantity, and a registration mode for each of a plurality of similar items subject to auction with a single purchase contract deposit amount as input into a computer;
displaying a plurality of purchase prices, a purchase quantity for each of said purchase prices, and a higher-price-accumulated purchase quantity for each of said purchase prices for each of said plurality of similar items, said higher-price-accumulated purchase quantity being obtained by summing all purchase quantities at a first purchase price and all higher purchase prices;
authorizing a sale of one of said higher-price-accumulated purchase quantities to a seller who first selects a purchase price corresponding to said one of said higher-price-accumulated purchase quantities for one of said plurality of similar items;
confirming said sale between said seller and all buyers associated with said corresponding purchase price or higher purchase prices for said one of said plurality of similar items; and
deleting a completed purchase quantity corresponding to said quantity purchased by said seller from said purchase quantities and said higher-price-accumulated purchase quantities for said plurality of similar items to accurately reflect post-sale purchase quantities.

17. A method for transacting goods G using a computer network, comprising the steps of:
receiving purchase offer information including a purchase price P and a purchase quantity A for the goods G;
adding said purchase quantity A to a purchase quantity Qᵢ of same purchase price Pᵢ as a purchase price P among a plurality of purchase prices P₁, . . . Pₙ as to the goods G for Pᵢ: 1 i n, Pᵢ>Pᵢ₊₁;
updating a higher-price-accumulated purchase quantity AQᵢ=₁ⁱQₘ of said plurality of purchase prices in response to said purchase quantity A;
providing purchase offer registration information including higher-price-accumulated purchase quantity AQ₁, AQ₂, . . . , AQₙ as to a plurality of purchase prices P₁, P₂, . . . , Pₙ of the goods G to a seller;
receiving a selection of said seller, said selection corresponding to one of said higher-price-accumulated purchase; and
confirming a transaction between said seller and all buyers, all buyers related to said higher-price-accumulated purchase quantity selected by said seller; whereby
said seller sells at a generally higher price and at greater convenience while all buyers buy at purchase offer purchase price or lower.

18. The method for transacting goods using a computer network according to claim 17, wherein said purchase offer registration information further includes each purchase total amount TA(1)ᵢ=₁ⁱPₘ×Qₘ for each of said plurality of purchase prices.

19. The method for transacting goods using a computer network according to claim 18, wherein each transaction price between all buyers and the seller is decided with purchase prices P₁. . . Pᵢ of each buyer.

20. The method for transacting goods using a computer network according to claim 17, wherein said purchase offer registration information further includes each purchase total amount TA(2)ᵢ=Pᵢ×AQᵢ of said plurality of purchase prices.

21. The method for transacting goods using a computer network according to claim 20, wherein a transaction price between all buyers and said seller is a purchase price Pi selected by said seller.

22. An apparatus for transacting goods G using a computer network, including:
a storage device arranged to store a bidirectional auction program;
a processor configured to execute said bidirectional auction program, said bi-directional auction program directing said processor to:
receive purchase offer information including a purchase price P and a purchase quantity A for the goods G;
add said purchase quantity A to a purchase quantity Qᵢ of same purchase price Pᵢ as a purchase price P among a plurality of purchase prices P₁. . . Pₙ as to the goods G for Pᵢ: 1 i n, Pᵢ>Pᵢ₊₁;
update a higher-price-accumulated purchase quantity AQᵢ=₁ⁱQₘ of said plurality of purchase prices in response to said purchase quantity A;
provide purchase offer registration information including higher-price-accumulated purchase quantity AQ₁, AQ₂, . . . , AQₙ as to a plurality of purchase prices P₁, P₂, . . . , Pₙ of the goods G to a seller;
receive a selection of said seller, said selection corresponding to one of said higher-price-accumulated purchase; and
confirm a transaction between said seller and all buyers, all buyers related to said higher-price-accumulated purchase quantity selected by said seller; whereby
said seller sells at a generally higher price and at greater convenience while all buyers buy at purchase offer purchase price or lower.

23. The apparatus for transacting goods using a computer network according to claim 22, wherein said purchase offer registration information further includes each purchase total amount for each of said plurality of purchase prices.

24. The apparatus for transacting goods using a computer network according to claim 23, wherein the purchase offer registration information further includes each purchase total amount TA(2)ᵢ=Pᵢ×AQᵢ of the plurality of purchase prices.

25. A method for providing purchase offer registration information, wherein goods G are dealt through a computer network, comprising the steps of:
receiving purchase offer information including a purchase price P and a purchase quantity A for the goods G;
adding said purchase quantity A to a purchase quantity Qᵢ of same purchase price Pᵢ as a purchase price P among a plurality of purchase prices P₁. . . Pₙ as to the goods G for Pᵢ: 1 i n, Pᵢ>Pᵢ₊₁;
updating a higher-price-accumulated purchase quantity AQᵢ=₁ⁱQₘ of said plurality of purchase prices in response to said purchase quantity A;
providing purchase offer registration information including higher-price-accumulated purchase quantity AQ₁, AQ₂, . . . , AQₙ as to a plurality of purchase prices P₁, P₂, . . . , Pₙ of the goods G to a seller.

26. The method for providing purchase offer registration information according to claim 25, wherein the selling offer registration information further includes each purchase total amount TA(1)ᵢ=₁ⁱPₘ×Qₘ for each of said plurality of purchase prices.

27. The method for providing purchase offer registration information according to claim 25, wherein said purchase offer registration information further includes each purchase total amount TA(2)ᵢ Pᵢ×AQᵢ for each of said plurality of purchase prices.

28. The method for providing purchase offer registration information according to claim 25, wherein said received purchase price P is registered as a new purchase price Pₖ and a purchase quantity Qₖ of the goods G in case that there is no purchase price Pᵢ equal to said received purchase price P among a plurality of purchase prices of the goods G.

29. The method for providing purchase offer registration information according to claim 26, wherein said purchase offer registration information further includes the number of buyers for each of said plurality of purchase prices.

30. A method for providing purchase offer registration information, wherein goods G are dealt through a computer network, comprising the steps of:
receiving purchase offer information including a purchase price P and a purchase quantity A for the goods G;
adding said purchase quantity A to a purchase quantity Qᵢ of same purchase price Pᵢ as a purchase price P among a plurality of purchase prices P₁. . . Pₙ as to the goods G for Pᵢ: 1 i n, Pᵢ>Pᵢ₊₁;
updating purchase total amount TA(1)ᵢ=₁ⁱPₘ×Qₘ of the plurality of purchase prices in response to the received purchase quantity A; and
providing a purchase offer registration information including each purchase total amount TA(1)₁, TA(1)₂, . . . , and TA(1)ₙ as to a plurality of corresponding purchase prices P₁, P₂, . . . , and Pₙ of the goods G to at least one seller.

31. The apparatus for providing purchase offer registration information according to claim 30, wherein said purchase offer registration information further includes each purchase total amount TA(2)ᵢ=Pᵢ×AQᵢ for each of said plurality of purchase prices.

32. A method for providing purchase offer registration information, wherein goods G are dealt through a computer network, comprising the steps of:
receiving purchase offer information including a purchase price P and a purchase quantity A for the goods G;
adding said purchase quantity A to a purchase quantity Qᵢ of same purchase price Pᵢ as a purchase price P among a plurality of purchase prices P₁. . . Pₙ as to the goods G for Pᵢ: 1 i n, Pᵢ>Pᵢ₊₁;
update a higher-price-accumulated purchase quantity AQᵢ=₁ⁱQₘ and a purchase total amount TA(2)ᵢ=Pᵢ×AQᵢ for each of said plurality of purchase prices in response to the received purchase quantity A; and
providing purchase offer registration information including each purchase total amount TA(2)₁, TA(2)₂, . . . , and TA(2)ₙ as to a plurality of corresponding purchase prices P₁, P₂, . . . , and Pₙ of the goods G to a seller.

33. An apparatus for providing purchase offer registration information, wherein goods G are dealt through a computer network, including:
a storage device arranged to store program for providing purchase offer registration information;
a processor configured to execute said program, said program directing said processor to:
receive purchase offer information including a purchase price P and a purchase quantity A for the goods G;
add said purchase quantity A to a purchase quantity Qᵢ of same purchase price Pᵢ as a purchase price P among a plurality of purchase prices P₁. . . Pₙ as to the goods G for Pᵢ: 1 i n, Pᵢ>Pᵢ₊₁;
update a higher-price-accumulated purchase quantity AQᵢ=₁ⁱQₘ and a purchase total amount TA(2)ᵢ=Pᵢ×AQᵢ for each of said plurality of purchase prices in response to the received purchase quantity A; and
provide purchase offer registration information including each purchase total amount TA(2)₁, TA(2)₂, . . . , and TA(2)ₙ as to a plurality of corresponding purchase prices P₁, P₂, . . . , and Pₙ, of the goods G to a seller.

34. The apparatus for providing purchase offer registration information according to claim 33, wherein the purchase offer registration information further includes a corresponding purchase total amount TA(1)ᵢ=₁ⁱPₘ×Qₘ for each of said plurality of purchase prices.

35. A storage medium encoded with machine-readable computer program code for bi-directionally auctioning using a computer network, the storage medium including instructions for causing a computer to implement a method comprising:
accepting as input a plurality of purchase prices for an item subject to auction and respective purchase quantities for said purchase prices;
calculating a higher-price-accumulated purchase quantity for each of said purchase prices, the higher-price-accumulated purchase quantity being calculated by summing purchase quantities at a first purchase price and all higher purchase prices for said item;
accepting as input a selection of a seller, said selection being one of said higher-price-accumulated purchase quantities acceptable by said seller in purchase total amount; and
consummating a sales transaction between said seller and all buyers related to said selected higher-price-accumulated purchase quantity.

36. A storage medium encoded with machine-readable computer program code for bi-directionally auctioning using a computer network, the storage medium including instructions for causing a computer to implement a method comprising:
accepting an item subject to auction, a purchase price, a purchase quantity, and a purchase contract deposit as input into a computer;
displaying on the computer a plurality of purchase prices for said item, a purchase quantity for each said purchase price, and a higher-price-accumulated purchase quantity for each said purchase price, said higher-price-accumulated purchase quantity being obtained by summing said purchase quantities at a first purchase price and all higher purchase prices for said item;
authorizing a sale of a higher-price-accumulated purchase quantity of said item to a seller; and
displaying confirmation of a transaction of one of said higher-price-accumulated purchase quantities between said seller being one who first selects said purchase price corresponding to one of said higher-price accumulated purchase quantities and all buyers related to said higher-price-accumulated quantity.

37. The storage medium of claim 36, further comprising instructions for causing the computer to implement accepting purchase term information as input into the computer.

38. The storage medium of claim 36, further comprising instructions for causing the computer to implement:
displaying a total amount for each purchase price, said total amount being obtained by multiplying said purchase price and a corresponding higher-price-accumulated purchase quantity.

39. The storage medium of claim 36, further comprising instructions for causing a computer to implement:
displaying a fluctuation of higher-price-accumulated purchase quantity.

40. A method for conducting a bidirectional auction, the steps comprising:
receiving buy bids from buyers for an item subject to auction;
presenting said buy bids in tabulated form to a seller, said seller selecting a quantity of said item that said seller will sell to one or more of said buyers.
consummating a sale between said seller and said one or more buyers for said quantity, a price paid by said one or more buyers for said item being a lowest price in a range of highest prices of said buy bids; whereby said seller sells said item at a higher price due to competitive buy bidding by said buyers while said one or more buyers buy said item at a bid price or lower due to quantity selling by said seller.

41. A method for conducting a bidirectional auction, the steps comprising:
receiving sell bids from sellers for an item subject to auction;
presenting said sell bids in tabular form to a buyer, said buyer selecting a quantity of said item that said buyer will buy from one or more of said sellers.
consummating a sale between said buyer and said one or more sellers for said quantity, a price paid by said buyer for said item being a highest price in a range of lowest prices of said sell bids; whereby said buyer buys said item at a lower price due to competitive sell bidding by said seller while said one or more sellers sell said item at a higher price or lower due to quantity buying by said buyer.
